(19) United States
(12) Patent Application Publication
(10) Pub. No.: US 2026/0148703 A1
(43) Pub. Date: May 28, 2026

(54) DISPLAY DEVICE

(71) Applicant: LG Display Co., Ltd., Seoul (KR)

(72) Inventors: SeongHo YUN, Paju-si (KR); Jeahun JUNG, Paju-si (KR)

(73) Assignee: LG Display Co., Ltd., Seoul (KR)

(21) Appl. No.: 19/341,570

(22) Filed: Sep. 26, 2025

(30) Foreign Application Priority Data
Nov. 22, 2024 (KR) 10-2024-0168124

(51) Int. Cl. G09G 3/3291

(52) U.S. Cl. CPC G09G 3/3291; G09G 2310/08; G09G 2330/021

(57) ABSTRACT

Examples Embodiments of the present disclosure may provide a display device including a display panel in which a plurality of sub-pixels are arranged and which displays an image, a data driving circuit configured to supply data voltages to the plurality of sub-pixels through data lines, first switches that supply pre-charge voltages to the data lines, and second switches that connect two data lines among the data lines, in which the data driving circuit supplies data voltages corresponding to image data to the plurality of sub-pixels, outputs a switching signal to each of the first switches based on an amount of change in the image data sequentially outputted, and outputs a control signal to each of the second switches based on the amount of change in the image data, thereby providing a display device capable of reducing power consumption.

### CROSS REFERENCE TO RELATED APPLICATION

This application claims the benefit of and priority to Korean Patent Application No. 10-2024-0168124, filed on Nov. 22, 2024, the entire contents of which are incorporated herein by reference for all purposes as if fully set forth herein.

### TECHNICAL FIELD

Embodiments of the present disclosure relate to a display device, and particularly to, for example, without limitation, a data driving circuit and a display device.

### DESCRIPTION OF RELATED ART

As the information society develops, the demand for display devices for displaying images is increasing in various forms, and recently, various types of display devices such as liquid crystal displays and organic light-emitting displays are being utilized.

These display devices require a data drive circuit capable of reducing power consumption and displaying images stably.

A conventional display device may have a problem in that a display device could not share voltage between lines outputting a data voltage. Accordingly, embodiments of the present disclosure proposes a data driving circuit and display device capable of sharing voltage by arranging a transistor between lines outputting the data voltages.

The description of related art should not be considered prior art merely because it is mentioned in or associated with this section. The description of related art includes information that describes one or more aspects of the subject technology, and the description in this section does not limit the scope of the invention.

### SUMMARY

Embodiments of the present disclosure may provide a data driving circuit and a display device that determines sharing of voltage between a plurality of lines according to a change in image data sequentially output from a data driving circuit.

Embodiments of the present disclosure may provide a display device including a display panel in which a plurality of sub-pixels are arranged and which is configured to display an image, a data driving circuit configured to supply data voltages to the plurality of sub-pixels through data lines, first switches configured to supply pre-charge voltages to the data lines, and second switches that connect two data lines among the data lines, wherein the data driving circuit is configured to sequentially supply data voltages corresponding to image data to a plurality of sub-pixels, to output a switching signal to each of the first switches based on an amount of change in the image data sequentially outputted, and to output a control signal to each of the second switches based on the amount of change in the image data.

According to embodiments of the present disclosure, it is possible to provide a data driving circuit and a display device including a plurality of transistors electrically connecting each of a plurality of data lines.

According to embodiments of the present disclosure, it is possible to provide a data driving circuit and a display device capable of charging a plurality of data lines by controlling a plurality of transistors.

According to embodiments of the present disclosure, it is possible to drive a display device at low power by providing a data driving circuit that shares voltage, current, and charge between a plurality of output circuits.

Additional features, advantages, and aspects of the present disclosure are set forth in part in the description that follows and in part will become apparent from the present disclosure or may be learned by practice of the inventive concepts provided herein. Other features, advantages, and aspects of the present disclosure may be realized and attained by the descriptions provided in the present disclosure, or derivable therefrom, and the claims hereof as well as the drawings. It is intended that all such features, advantages, and aspects be included within this description, be within the scope of the present disclosure, and be protected by the following claims. Nothing in this section should be taken as a limitation on those claims. Further features, advantages, and aspects are discussed below in conjunction with embodiments of the present disclosure.

It is to be understood that both the foregoing description and the following description of the present disclosure are examples, and are intended to provide further explanation of the disclosure as claimed.

### BRIEF DESCRIPTION OF THE DRAWINGS

The accompanying drawings, which are included to provide a further understanding of the present disclosure, are incorporated in and constitute a part of this present disclosure, illustrate aspects and embodiments of the present disclosure, and together with the description serve to explain principles and examples of the disclosure.

FIG. 1 is a system configuration diagram of a display device according to embodiments of the present disclosure.

FIG. 2 illustrates a display device including a switch control unit according to embodiments of the present disclosure.

FIG. 3 is an equivalent circuit diagram of a sub-pixel included in a display device according to embodiments of the present disclosure.

FIG. 4 illustrates a connection relationship between a plurality of switching transistors, a switch control unit, and a plurality of output circuits according to embodiments of the present disclosure.

FIG. 5 illustrates a switch control unit that outputs a control signal according to a signal output from a shift register according to embodiments of the present disclosure.

FIG. 6 illustrates a connection relationship between a plurality of switching transistors, a switch control unit, a plurality of output circuits, and a plurality of logic units according to embodiments of the present disclosure.

FIG. 7 illustrates a switch control unit that outputs a control signal according to a signal output from a logic unit according to embodiments of the present disclosure.

FIG. 8 is a timing diagram of a plurality of signals according to a change in a MSB value according to embodiments of the present disclosure.

FIG. 9 is a table illustrating power consumption reduction conditions according to various embodiments of the present disclosure.

Throughout the drawings and the detailed description, unless otherwise described, the same drawing reference numerals should be understood to refer to the same elements, features, and structures. The sizes, lengths, and thicknesses of layers, regions and elements, and depiction thereof may be exaggerated for clarity, illustration, and/or convenience.

### DETAILED DESCRIPTION

In the following description of examples or embodiments of the present invention, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present invention, detailed descriptions of well-known functions and components incorporated herein will be omitted when it is determined that the description may make the subject matter in some embodiments of the present invention rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise. For example, an element may be one or more elements. An element may include a plurality of elements. The word “exemplary” is used to mean serving as an example or illustration. Embodiments are example embodiments. Aspects are example aspects. In one or more implementations, “embodiments,” “examples,” “aspects,” and the like should not be construed to be preferred or advantageous over other implementations. An embodiment, an example, an example embodiment, an aspect, or the like may refer to one or more embodiments, one or more examples, one or more example embodiments, one or more aspects, or the like, unless stated otherwise.

Terms, such as “first”, “second”, “A”, “B”, “(A)”, or “(B)” may be used herein to describe elements of the present invention. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after”, “subsequent to”, “next”, “before”, and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

Hereinafter, it will be described various embodiments of the disclosure in detail with reference to the accompanying drawings.

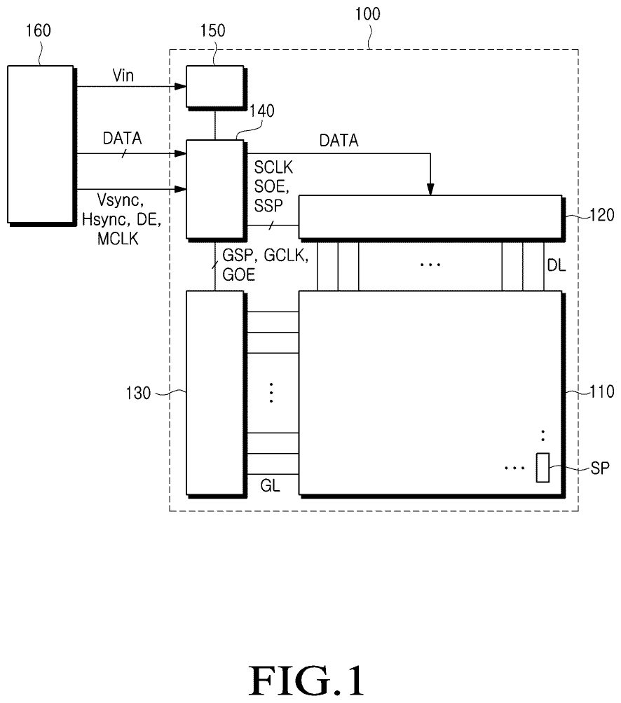

FIG. 1 is a system configuration diagram of a display device 100 according to embodiments of the present disclosure.

FIG. 1 illustrates a schematic configuration of a display device according to embodiments of the present disclosure.

Referring to FIG. 1, a display device 100 according to embodiments of the present disclosure may include a display panel 110 in which a plurality of gate lines GL and data lines DL are connected and a plurality of sub-pixels SP are arranged in a matrix form, a gate driving circuit 130 for driving a plurality of gate lines GL, a data driving circuit 120 for supplying data voltage through a plurality of data lines DL, a controller 140 for controlling the gate driving circuit 130 and the data driving circuit 120, and a power management circuit 150.

The display panel 110 may display an image based on a scan signal transmitted from the gate driving circuit 130 through the plurality of gate lines GL and a data voltage transmitted from the data driving circuit 120 through the plurality of data lines DL.

The display panel 110 may include a plurality of pixels arranged in a matrix form, and each pixel may be composed of sub-pixels SP of different colors, for example, a white sub-pixel, a red sub-pixel, a green sub-pixel, and a blue sub-pixel. In addition, each sub-pixel SP may be defined by a plurality of data lines DL and a plurality of gate lines GL.

One sub-pixel SP may include a thin film transistor (TFT) formed in an area where one data line DL and one gate line GL intersect, a light emitting device such as an organic light-emitting diode that charges a data voltage, and a storage capacitor that is electrically connected to the light emitting device to maintain the voltage.

For example, if a display device 100 having a resolution of 2,160×3,840 is composed of three sub-pixels SP of red (R), green (G), and blue (B), a total of 11,520 (i.e., 3,840×3) data lines DL may be provided by 2,160 gate lines GL and 3,840 data lines DL respectively connected to the three sub-pixels (RGB), and a sub-pixel SP may be arranged at each point where the gate lines GL and data lines DL intersect.

The gate driving circuit 130 may be controlled by the controller 140, and may control the driving timing for a plurality of sub-pixels SP by sequentially outputting scan signals to a plurality of gate lines GL arranged on the display panel 110.

In this case, the gate driving circuit 130 may include one or more gate driving integrated circuits GDIC, and may be located only on one side of the display panel 110 or on both sides of the display panel 110 depending on the driving method. Alternatively, the gate driving circuit 130 may be built into a bezel area of the display panel 110 and implemented in the form of a gate-in-panel (GIP).

The data driving circuit 120 may receive image data DATA from the controller 140 and convert the received image data DATA into an analog data voltage. The data driving circuit 120 may output the data voltage to each data line DL in accordance with the timing at which the scan signal is applied through the gate line GL, so that each sub-pixel SP connected to the data line DL emits the light of brightness corresponding to the data voltage.

Similarly, the data driving circuit 120 may include one or more source driving integrated circuits SDIC, and the source driving integrated circuits SDIC may be connected to bonding pads of the display panel 110 in a tape automated bonding (TAB) manner or a chip-on-glass (COG) manner or may be directly placed on the display panel 110.

In some cases, each source driving integrated circuit SDIC may be integrated and disposed on the display panel 110. In addition, each source driving integrated circuit SDIC may be implemented in a chip-on-film (COF) manner, and in this case, each source driving integrated circuit SDIC may be mounted on a circuit film and electrically connected to a data line DL of the display panel 110 through the circuit film.

The controller 140 may supply various control signals to the gate driving circuit 130 and the data driving circuit 120, and control the operation of the gate driving circuit 130 and the data driving circuit 120. That is, the controller 140 may control the gate driving circuit 130 to output a scan signal according to the timing implemented in each frame, and may transmit image data DATA received from the outside to the data driving circuit 120.

In this case, the controller 140 may receive various timing signals including a vertical synchronization signal Vsync, a horizontal synchronization signal Hsync, a data enable signal DE, and a main clock MCLK together with the image data DATA from an external host system 160.

The host system 160 may be any one of a TV system, a set-top box, a navigation system, a personal computer (PC), a home theater system, a mobile device, and a wearable device.

Accordingly, the controller 140 may generate a control signal using various timing signals received from the host system 160, and transmit the control signal to the gate driving circuit 130 and the data driving circuit 120.

For example, the controller 140 may output various gate control signals including a gate start pulse GSP, a gate clock GCLK, and a gate output enable signal GOE in order to control the gate driving circuit 130. Here, the gate start pulse GSP is a signal for controlling the operation starting time of one or more gate driving integrated circuits GDIC constituting the gate driving circuit 130. In addition, the gate clock GCLK may be a clock signal commonly input to one or more gate driving integrated circuits GDIC to control the shift timing of the scan signal. In addition, the gate output enable signal GOE may be a signal for specifying the timing information of one or more gate driving integrated circuits GDIC.

In addition, the controller 140 may output various data control signals including a source start pulse SSP, a source clock SCLK, and a source output enable signal SOE in order to control the data driving circuit 120. Here, the source start pulse SSP may be a signal for controlling the timing at which one or more source driving integrated circuits SDIC constituting the data driving circuit 120 start data sampling. The source clock SCLK may be a clock signal that controls the timing at which data is sampled in the source driving integrated circuit SDIC. The source output enable signal SOE may be a signal for controlling the output timing of the data driving circuit 120.

The display device 100 may include a power management circuit 150 that supplies various voltages or currents to the display panel 110, the gate driving circuit 130, the data driving circuit 120, or controls various voltages or currents to be supplied.

The power management circuit 150 may adjust the DC input voltage Vin supplied from the host system 160 to generate power necessary for driving the display panel 110, the gate driving circuit 130, and the data driving circuit 120.

Meanwhile, the sub-pixel SP may be located at the point where the gate line GL and the data line DL intersect, and a light emitting device may be arranged in each sub-pixel SP. For example, an organic light-emitting display device may include a light emitting device such as an organic light-emitting diode in each sub-pixel SP, and may display an image by controlling the current flowing to the light emitting device according to the data voltage.

The display device 100 may be various types of devices such as a liquid crystal display, an organic light emitting display, and a plasma display panel.

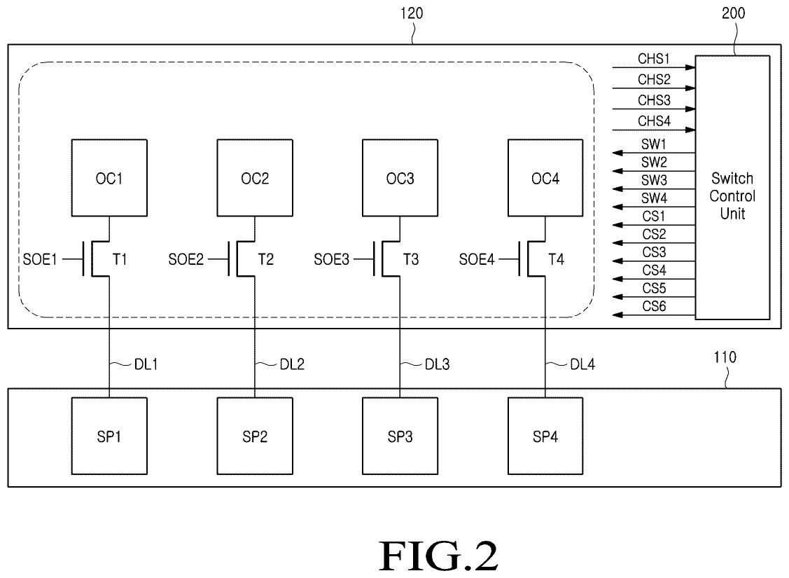

FIG. 2 illustrates a display device 100 including a switch control unit 200 according to embodiments of the present disclosure.

Referring to FIG. 2, the display device 100 may include a data driving circuit 120 and a display panel 110.

The data driving circuit 120 may include a plurality of output circuits OC that sequentially output data voltages corresponding to image data DATA. For example, the data driving circuit 120 may include a first output circuit OC1, a second output circuit OC2, a third output circuit OC3, and a fourth output circuit OC4. The data driving circuit 120 may include a switch control unit 200.

The display panel 110 may include a plurality of sub-pixels SP. For example, the display panel 110 may include a first sub-pixel SP1, a second sub-pixel SP2, a third sub-pixel SP3, and a fourth sub-pixel SP4. For example, the first sub-pixel SP1 may be a red sub-pixel. The second sub-pixel SP2 may be a white sub-pixel. The third sub-pixel SP3 may be a green sub-pixel. The fourth sub-pixel SP4 may be a blue sub-pixel.

The output circuits OC1 to OC4 may be electrically connected to the sub-pixels SP1 to SP4 and data lines DL1 to DL4, respectively.

The first output circuit OC1 may output first image data to the first sub-pixel SP1 in response to a first source output enable signal SOE1 through a first data line DL1. The second output circuit OC2 may output second image data to the second sub-pixel SP2 in response to a second source output enable signal SOE2 through a second data line DL2. The third output circuit OC3 may output third image data to the third sub-pixel SP3 in response to a third source output enable signal SOE3 through a third data line DL3. The fourth output circuit OC4 may output fourth image data to the fourth sub-pixel SP4 in response to a fourth source output enable signal SOE4 through a fourth data line DL4.

Hereinafter, it will be described the operation of the display device 100 according to an example in which the data voltage is output during the source output enable signal SOE has a high level.

Sharing at least one of charge, voltage, and current between data lines may be referred to as charge-share. Sharing at least one of charge, voltage, and current by connecting a data line to a predetermined voltage line may be referred to as pre-charge.

Before outputting the data voltage corresponding to the image data DATA, at least one data line DL may be pre-charged, or the plurality of data lines DL may be charge-shared in order to prevent the phenomenon of insufficient charging of the plurality of data lines DL or to save power consumption.

The switch control unit 200 may control the pre-charge and charge-share of the plurality of data lines DL. For example, while the first source enable signal SOE1 has a low level, the first data line DL1 may be pre-charged or charge-shared. For example, while the second source enable signal SOE2 has a low level, the second data line DL2 may be pre-charged or charge-shared. For example, while the third source enable signal SOE3 has a low level, the third data line DL3 may be pre-charged or charge-shared. For example, while the fourth source enable signal SOE4 has a low level, the fourth data line DL4 may be pre-charged or charge-shared.

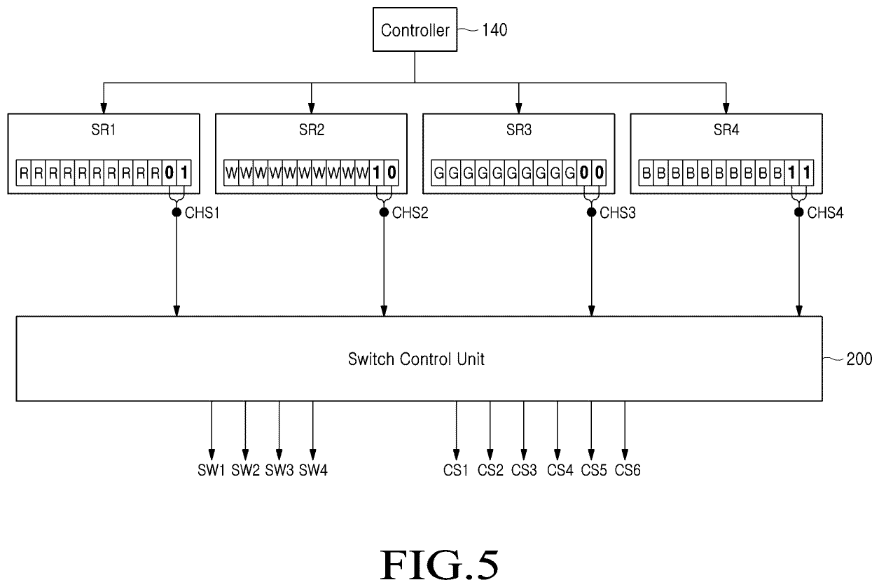

The plurality of output circuits may each output a channel signal CHS to the switch control unit 200. For example, the first output circuit OC1 may output a first channel signal CHS1 to the switch control unit 200. The second output circuit OC2 may output a second channel signal CHS2 to the switch control unit 200. The third output circuit OC3 may output a third channel signal CHS3 to the switch control unit 200. The fourth output circuit OC4 may output a fourth channel signal CHS4 to the switch control unit 200. Detailed descriptions of the first channel signal CHS1, the second channel signal CHS2, the third channel signal CHS3, and the fourth channel signal CHS4 are exemplified in the description of FIG. 5.

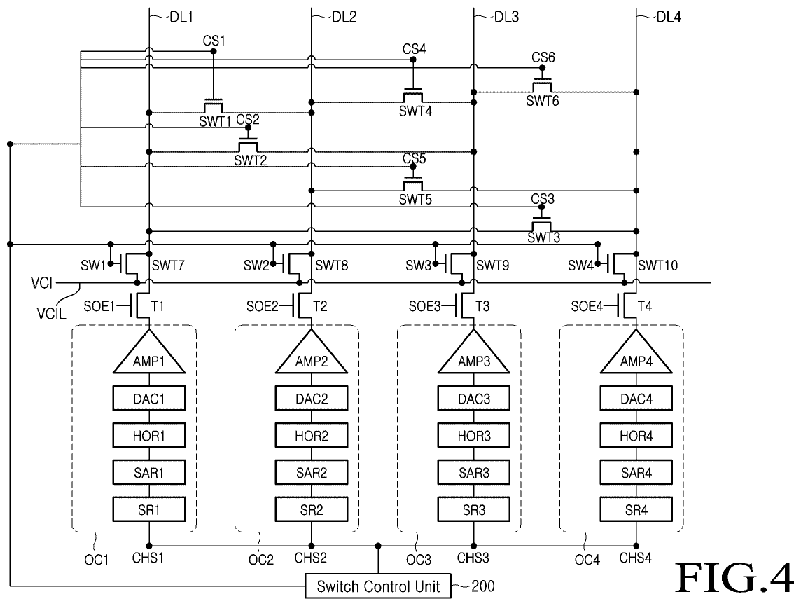

The switch control unit 200 may output a first control signal CS1, a second control signal CS2, a third control signal CS3, a fourth control signal CS4, a fifth control signal CS5, and a sixth control signal CS6 to a plurality of transistors electrically connecting a plurality of output circuits, respectively, according to a first channel signal CHS1, a second channel signal CHS2, a third channel signal CHS3, and a fourth channel signal CHS4. The switch control unit 200 may output a first switching signal SW1, a second switching signal SW2, a third switching signal SW3, and a fourth switching signal SW4 to a plurality of transistors controlling a connection between a control voltage line that pre-charges a plurality of data lines DL and the plurality of data lines DL. A detailed description of the plurality of transistors will be exemplified in the description of FIG. 4.

The pre-charge and charge-share of the plurality of data lines DL may be controlled according to the first switching signal SW1, the second switching signal SW2, the third switching signal SW3, the fourth switching signal SW4, the first control signal CS1, the second control signal CS2, the third control signal CS3, the fourth control signal CS4, the fifth control signal CS5, and the sixth control signal CS6. The description of the first switching signal SW1, the second switching signal SW2, the third switching signal SW3, the fourth switching signal SW4, the first control signal CS1, the second control signal CS2, the third control signal CS3, the fourth control signal CS4, the fifth control signal CS5, and the sixth control signal CS6 will be exemplified in the description of FIG. 4.

Hereinafter, it will be described a sub-pixel SP driven by a data voltage output from an output circuit.

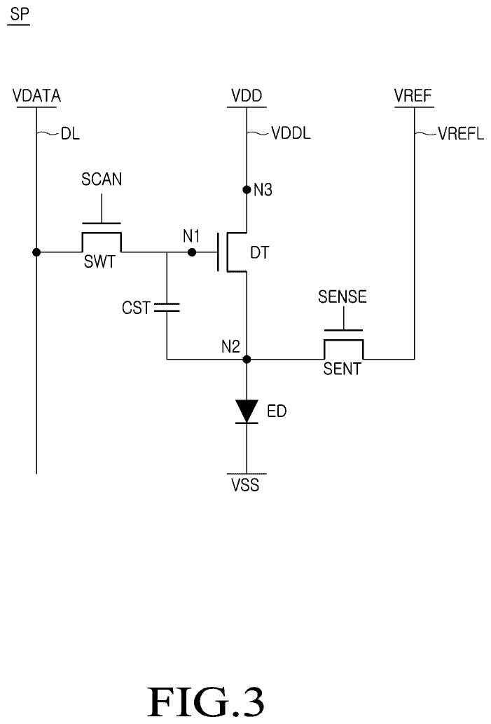

FIG. 3 is an equivalent circuit diagram of a sub-pixel SP included in a display device 100 according to embodiments of the present disclosure.

Referring to FIG. 3, in a display device 100 according to embodiments of the present disclosure, a sub-pixel SP may include one or more transistors and capacitors, and an organic light-emitting diode may be disposed as a light emitting device ED.

For example, a sub-pixel SP may include a driving transistor DT, a switching transistor SWT, a sensing transistor SENT, a storage capacitor CST, and a light emitting device ED.

The driving transistor DT may have a first node N1, a second node N2, and a third node N3. The first node N1 of the driving transistor DT may be a gate node to which a data voltage VDATA is applied from a data driving circuit 120 via a data line DL when the switching transistor SWT is turned on. The second node N2 of the driving transistor DT may be electrically connected to an anode electrode of a light emitting device ED and may be a source node or a drain node. The third node N3 of the driving transistor DT may be electrically connected to a driving voltage line VDDL to which a driving voltage VDD is applied and may be a drain node or a source node.

In this case, during a display driving period, a driving voltage VDD required for displaying an image may be supplied to the driving voltage line VDDL.

The switching transistor SWT may be electrically connected between the first node N1 of the driving transistor DT and the data line DL, and the gate line GL may be connected to the gate node, and operate according to a scan signal SCAN supplied through the gate line GL. In addition, if the switching transistor SWT is turned on, the data voltage VDATA supplied through the data line DL may be transferred to the gate node of the driving transistor DT, thereby controlling the operation of the driving transistor DT.

The sensing transistor SENT may be electrically connected between the second node N2 of the driving transistor DT and a reference voltage line VREFL, and the gate line may be connected to the gate node to operate according to a sense signal SENSE supplied through the gate line. If the sensing transistor SENT is turned on, a sensing reference voltage VREF supplied through the reference voltage line VREFL is transferred to the second node N2 of the driving transistor DT.

That is, the first node N1 voltage and the second node N2 voltage of the driving transistor DT may be controlled by controlling the switching transistor SWT and the sensing transistor SENT, thereby enabling current to be supplied to drive the light emitting device ED.

The gate nodes of the switching transistor SWT and the sensing transistor SENT may be connected together to one gate line GL, or may be connected to different gate lines GL. Here, it is exemplified a structure in which the switching transistor SWT and the sensing transistor SENT are connected to different gate, and in this case, the switching transistor SWT and the sensing transistor SENT may be independently controlled by the scan signal SCAN and the sense signal SENSE transmitted through different gate lines.

Meanwhile, in the case that the switching transistor SWT and the sensing transistor SENT are connected to one gate line GL, the switching transistor SWT and the sensing transistor SENT may be simultaneously controlled by the scan signal SCAN or the sense signal SENSE transmitted through one gate line, thereby increasing the aperture ratio of the sub-pixel SP.

Meanwhile, the transistor disposed in the sub-pixel SP may be composed of not only an n-type transistor but also a p-type transistor, Hereinafter, it will be exemplified a case where the transistor is composed of an n-type transistor.

The storage capacitor CST may be electrically connected between the first node N1 and the second node N2 of the driving transistor DT, and maintain the data voltage VDATA for one frame.

The storage capacitor CST may be connected between the first node N1 and the third node N3 of the driving transistor DT depending on the type of the driving transistor DT. The anode electrode of the light emitting device ED may be electrically connected to the second node N2 of the driving transistor DT, and a base voltage VSS may be applied to a cathode electrode of the light emitting device ED.

Here, the base voltage VSS may be a ground voltage or a voltage higher or lower than the ground voltage. In addition, the base voltage VSS may be variable depending on the driving state. For example, the base voltage VSS at the display driving time and the base voltage VSS at the sensing driving time may be set differently from each other.

The structure of the sub-pixel SP described above as an example is a 3T (Transistor) 1C (Capacitor) structure, and is only an example for explanation. The sub-pixel may include one or more transistors or, in some cases, one or more capacitors. Alternatively, each of the plurality of sub-pixels SP may have the same structure, or some of the plurality of sub-pixels SP may have different structures.

FIG. 4 illustrates a connection relationship between a plurality of switching transistors SWT1 to SWT10, a switch control unit 200, and a plurality of output circuits OC1 to OC4 according to embodiments of the present disclosure.

The data driving circuit 120 may include a first output circuit OC1, a second output circuit OC2, a third output circuit OC3, and a fourth output circuit OC4. A plurality of data lines DL1 to DL4 may be connected to a control voltage line VCIL that outputs a pre-charge voltage VCI. The data driving circuit 120 may include a switch control unit 200. It will be omitted the descriptions of the switch control unit 200 overlapping with the description of FIG. 2.

A first switching transistor SWT1 may control an electrical connection between a first data line DL1 and a second data line DL2. A second switching transistor SWT2 may control an electrical connection between the first data line DL1 and a third data line DL3. A third switching transistor SWT3 may control an electrical connection between the first data line DL1 and a fourth data line DL4. A fourth switching transistor SWT4 may control an electrical connection between the second data line DL2 and the third data line DL3. A fifth switching transistor SWT5 may control an electrical connection between the second data line DL2 and the fourth data line DL4. A sixth switching transistor SWT6 may control an electrical connection between the third data line DL3 and the fourth data line DL4.

The plurality of output circuits may include a shift register SR, a sampling latch circuit SAR, a holding latch circuit HOR, a digital-to-analog converter DAC, and an amplifier AMP.

For example, the first output circuit OC1 may include a first shift register SR1, a first sampling latch circuit SAR1, a first holding latch circuit HOR1, a first digital-to-analog converter DAC1, and a first amplifier AMP1. The first output circuit OC1 may be connected to a first data line DL1, a seventh switching transistor SWT7 controlling pre-charge of the first data line DL1, and a first transistor T1 controlling output of a first data voltage corresponding to the first image data according to a first source enable signal SOE1.

For example, the second output circuit OC2 may include a second shift register SR2, a second sampling latch circuit SAR2, a second holding latch circuit HOR2, a second digital-to-analog converter DAC2, and a second amplifier AMP2. The second output circuit OC2 may be connected to a second data line DL2, an eighth switching transistor SWT8 controlling pre-charge of the second data line DL2, and a second transistor T2 controlling output of a second data voltage corresponding to the second image data according to a second source enable signal SOE2.

For example, the third output circuit OC3 may include a third shift register SR3, a third sampling latch circuit SAR3, a third holding latch circuit HOR3, a third digital-to-analog converter DAC3, and a third amplifier AMP3. The third output circuit OC3 may be connected to the third data line DL3, a ninth switching transistor SWT9 controlling the pre-charge of the third data line DL3, and a third transistor T3 controlling the output of a third data voltage corresponding to the third image data according to a third source enable signal SOE3.

For example, the fourth output circuit OC4 may include the fourth shift register SR4, the fourth sampling latch circuit SAR4, the fourth holding latch circuit HOR4, the fourth digital-to-analog converter DAC4, and the fourth amplifier AMP4. The fourth output circuit OC4 may be connected to the fourth data line DL4, a tenth switching transistor SWT10 controlling the pre-charge of the fourth data line DL4, and the fourth transistor T4 controlling the output of a fourth data voltage corresponding to the fourth image data according to a fourth source enable signal SOE4.

The seventh switching transistor SWT7, the eighth switching transistor SWT8, the ninth switching transistor SWT9, and the tenth switching transistor SWT10 may be referred to as a first pre-charge transistor, a second pre-charge transistor, a third pre-charge transistor, and a fourth pre-charge transistor, respectively.

The switch control unit 200 may receive a first channel signal CHS1, a second channel signal CHS2, a third channel signal CHS3, and a fourth channel signal CHS4 from the first shift register SR1, the second shift register SR2, the third shift register SR3, and the fourth shift register SR4, respectively.

The switch control unit 200 may control the turn-on state and the turn-off state of each of the plurality of switching transistors SWT1 to SWT10. The on-off of the plurality of switching transistors may be controlled according to the plurality of control signals output from the switch control unit 200 to the plurality of switching transistors and the voltage levels of the plurality of switching signals.

For example, the switch control unit 200 may provide a first control signal CS1 to a gate node of a first switching transistor SWT1 and output a second control signal CS2 to a gate node of a second switching transistor SWT2. The switch control unit 200 may output a third control signal CS3 to a gate node of a third switching transistor SWT3 and output a fourth control signal CS4 to a gate node of a fourth switching transistor SWT4. The switch control unit 200 may output a fifth control signal CS5 to a gate node of a fifth switching transistor SWT5. The switch control unit 200 may output a sixth control signal CS6 to a gate node of a sixth switching transistor SWT6.

For example, the switch control unit 200 may output a first switching signal SW1 to a gate node of a seventh switching transistor SWT7. For example, the switch control unit 200 may output a second switching signal SW2 to a gate node of an eighth switching transistor SWT8. For example, the switch control unit 200 may output a third switching signal SW4 to a gate node of a ninth switching transistor SWT9. For example, the switch control unit 200 may output a fourth switching signal SW4 to a gate node of a tenth switching transistor SWT10.

The phenomenon in which the voltage levels of the connected data lines change as the data lines DL are connected to each other before the output circuits output the data voltage in response to the source enable signal SOE may be referred to as charge-share. For example, the voltage of two connected data lines DL may change to a voltage value that is the sum of a voltage of a high voltage data line DL and a voltage of a low voltage data line DL and then divided by 2.

For example, if the first switching transistor SWT1 is turned on in response to the first control signal CS1, the first data line DL1 and the second data line DL2 may be electrically connected.

Accordingly, the charge of the data line having the higher voltage among the voltages of the first data line DL1 and the second data line DL2 and the charge of the data line having the lower voltage may be shared. If the voltage levels of the first data line DL1 and the second data line DL2 become the same due to the sharing of the charge, the data line having the lower voltage among the first data line DL1 and the second data line DL2 may be charged, and the data line having the higher voltage may be discharged.

For example, if the second control signal CS2 having the turn-on level is input to the gate node of the second switching transistor SWT2, the first data line DL1 and the third data line DL3 may be electrically connected.

Accordingly, the charge of the data line having the higher voltage among the voltages of the first data line DL1 and the third data line DL3 and the charge of the data line having the lower voltage may be shared. If the voltage levels of the first data line DL1 and the third data line DL3 become the same due to the sharing of the charge, the data line having the lower voltage among the first data line DL1 and the third data line DL3 may be charged, and the data line having the higher voltage may be discharged.

For example, if the third control signal CS3 having the turn-on level is input to the gate node of the third switching transistor SWT3, the first data line DL1 and the fourth data line DL4 may be electrically connected.

Accordingly, the charge of the data line having the higher voltage among the voltages of the first data line DL1 and the fourth data line DL4 and the charge of the data line having the lower voltage may be shared. As the voltage levels of the first data line DL1 and the fourth data line DL4 become the same due to the charge-share, the data line having the lower voltage among the first data line DL1 and the fourth data line DL4 may be charged, and the data line having the higher voltage may be discharged.

For example, if the fourth control signal CS4 having the turn-on level is input to the gate node of the fourth switching transistor SWT4, the second data line DL2 and the third data line DL3 may be electrically connected.

Accordingly, the charge of the data line having the higher voltage among the voltages of the second data line DL2 and the third data line DL3 and the charge of the data line having the lower voltage may be shared. As the voltage levels of the second data line DL2 and the third data line DL3 become the same due to the charge-share, the data line having the lower voltage among the second data line DL2 and the third data line DL3 may be charged, and the data line having the higher voltage may be discharged.

For example, if the fifth control signal CS5 having the turn-on level is input to the gate node of the fifth switching transistor SWT5, the second data line DL2 and the fourth data line DL4 may be electrically connected.

Accordingly, the charge of the data line having the higher voltage among the voltage of the second data line DL2 and the voltage of the fourth data line DL4 and the charge of the data line having the lower voltage may be shared. As the voltage levels of the second data line DL2 and the fourth data line DL4 become the same due to the charge-share, the data line having the lower voltage among the second data line DL2 and the fourth data line DL4 may be charged, and the data line having the higher voltage may be discharged.

For example, if the sixth control signal CS6 having the turn-on level is input to the gate node of the sixth switching transistor SWT6, the third data line DL3 and the fourth data line DL4 may be electrically connected.

Accordingly, the charge of the data line having the higher voltage among the voltages of the third data line DL3 and the fourth data line DL4 and the charge of the data line having the lower voltage may be shared. If the voltage levels of the third data line DL3 and the fourth data line DL4 become the same due to the charge-share, the data line having the lower voltage among the third data line DL3 and the fourth data line DL4 may be charged, and the data line having the higher voltage may be discharged.

The control voltage line VCIL and the output circuit are electrically connected before the output circuit outputs the data voltage VDATA in response to the source enable signal SOE, so that the data line DL included in the output circuit may be charged. The phenomenon in which the data line DL of the output circuit is charged by electrically connecting the control voltage line VCIL and the output circuit may be referred to as a pre-charge phenomenon.

For example, if the switch control unit 200 inputs a first switching signal SW1 having a turn-on level to the gate node of the seventh switching transistor SWT7, the control voltage line VCIL and the first data line DL1 may be electrically connected. If the control voltage line VCIL and the first data line DL1 are electrically connected, the first data line DL1 may be charged.

For example, if the switch control unit 200 inputs a second switching signal SW2 having a turn-on level to the gate node of the eighth switching transistor SWT8, the control voltage line VCIL and the second data line DL2 may be electrically connected, and the second data line DL2 may be charged.

For example, if the switch control unit 200 inputs a third switching signal SW3 having a turn-on level to the gate node of the ninth switching transistor SWT9, the control voltage line VCIL and the third data line DL3 may be electrically connected, and the third data line DL3 may be charged.

For example, if the switch control unit 200 inputs a fourth switching signal SW4 having a turn-on level to the gate node of the tenth switching transistor SWT10, the control voltage line VCIL and the fourth data line DL4 may be electrically connected, and the fourth data line DL4 may be charged.

The first sampling latch circuit SAR1 may sequentially sample the first image data supplied from the controller 140 according to a sampling signal and supply the sampled data to the first holding latch circuit HOR1. The second sampling latch circuit SAR2 may sequentially sample the second image data supplied from the controller 140 according to the sampling signal and supply the sampled data to the second holding latch circuit HOR2. The third sampling latch circuit SAR3 may sequentially sample the third image data supplied from the controller 140 according to the sampling signal and supply the sampled data to the third holding latch circuit HOR3. The fourth sampling latch circuit SAR4 may sequentially sample the fourth image data supplied from the controller 140 according to the sampling signal and supply the sampled data to the fourth holding latch circuit HOR4.

The first holding latch circuit HOR1 may store first image data sampled from the first sampling latch circuit SAR1, and supply the stored first image data to the first digital-to-analog converter DAC1 in synchronization with the source output enable signal SOE. The second holding latch circuit HOR2 may store second image data sampled from the second sampling latch circuit SAR2, and supply the stored second image data to the second digital-to-analog converter DAC2 in synchronization with the source output enable signal SOE. The third holding latch circuit HOR3 may store third image data sampled from the third sampling latch circuit SAR3, and supply the stored third image data to the third digital-to-analog converter DAC3 in synchronization with the source output enable signal SOE. The fourth holding latch circuit HOR4 may store the fourth image data sampled from the fourth sampling latch circuit SAR4 and supply the stored fourth image data to the fourth digital-to-analog converter DAC4 in synchronization with the source output enable signal SOE.

The first digital-to-analog converter DAC1 may convert image data supplied from the first holding latch circuit HOR1 into an analog voltage. The second digital-to-analog converter DAC2 may convert image data supplied from the second holding latch circuit HOR2 into an analog voltage. The third digital-to-analog converter DAC3 may convert image data supplied from the third holding latch circuit HOR3 into an analog voltage. The fourth digital-to-analog converter DAC4 may convert image data supplied from the fourth holding latch circuit HOR4 into an analog voltage.

The first amplifier AMP1 may amplify or compensate for an analog voltage transmitted from the first digital-to-analog converter DAC1 and supply the data voltage to the first data line DL1. The second amplifier AMP2 may amplify or compensate for an analog voltage transmitted from the second digital-to-analog converter DAC2 and supply the data voltage to the second data line DL2. The third amplifier AMP3 may amplify or compensate for an analog voltage transmitted from the third digital-to-analog converter DAC3 and supply the data voltage to the third data line DL3. The fourth amplifier AMP4 may amplify or compensate for an analog voltage transmitted from the fourth digital-to-analog converter DAC4 and supply the data voltage to the fourth data line DL4. In one embodiment, the first to fourth amplifiers AMP1 to AMP4 may be implemented as buffer amplifiers.

The first transistor T1 may control an electrical connection between the first amplifier AMP1 and the first data line DL1 in response to a first source enable signal SOE1. The second transistor T2 may control an electrical connection between the second amplifier AMP2 and the second data line DL2 in response to a second source enable signal SOE2. The third transistor T3 may control the electrical connection between the third amplifier AMP3 and the third data line DL3 in response to a third source enable signal SOE3. The fourth transistor T4 may control the electrical connection between the fourth amplifier AMP4 and the fourth data line DL4 in response to a fourth source enable signal SOE4.

Hereinafter, it will be described an operation of the switch control unit 200 to output a plurality of signals according to the first channel signal CHS1, the second channel signal CHS2, the third channel signal CHS3, and the fourth channel signal CHS4.

FIG. 5 illustrates a switch control unit 200 that outputs a control signal according to a signal output from a shift register according to embodiments of the present disclosure.

Referring to FIG. 5, the controller 140 may control the output of the channel signals CHS1 to CHS4 according to an amount of change in the image data sequentially provided to each output circuit. For example, the controller 140 may determine the output of the plurality of channel signals CHS1 to CHS4 according to the change of the most significant bit (also referred to as ‘MSB’) of the image data input to each of the plurality of output circuits OC1 to OC4.

For example, if the value of the MSB of the image data changes from ‘0’ to ‘1’, the controller 140 may determine the channel signal of the corresponding channel as a first signal. For example, if the value of the MSB of the image data changes from ‘1’ to ‘0’, the controller 140 may determine the channel signal of the corresponding channel as a second signal. For example, if the value of the MSB of the image data is maintained as ‘0’, the controller 140 may determine the channel signal of the corresponding channel as a third signal. For example, if the value of the MSB of the image data is maintained as ‘1’, the controller 140 may determine the channel signal of the corresponding channel as the third signal. Hereinafter, the operation of the data driving circuit 120 will be explained by taking as an example that the MSB has a high signal when the MSB value of the image data is ‘1’. The operation of the data driving circuit 120 may be explained by taking as an example that the MSB has a low signal when the MSB value of the image data is ‘0’.

The first signal may be a signal having a digital value of ‘01’. The second signal may be a signal having a digital value of ‘10’. The third signal may be a signal having a digital value of ‘00’. The third signal may be a signal having a digital value of ‘11’.

For example, the controller 140 may determine a channel signal according to a change in the value of the most significant 2 bits of the image data DATA input to a plurality of output circuits. For example, if the value of the most significant 2 bits of the image data DATA changes from ‘00’ to ‘11’, the controller 140 may determine the channel signal of the corresponding channel as a first signal. For example, if the value of the most significant 2 bits of the image data DATA changes from ‘11’ to ‘00’, the controller 140 may determine the channel signal of the corresponding channel as a second signal. For example, if the value of the most significant 2 bits of the image data DATA changes from ‘00’ to ‘10’, the controller 140 may determine the channel signal of the corresponding channel as the first signal. For example, if the value of the most significant 2 bits of the image data DATA changes from ‘11’ to ‘01’, the controller 140 may determine the channel signal of the corresponding channel as the second signal. For example, if the value of the most significant 2 bits of the image data DATA remains at ‘00’, the controller 140 may determine the channel signal of the corresponding channel as the third signal. For example, if the value of the most significant 2 bits of the image data DATA remains as ‘11’, the controller 140 may determine the channel signal of the corresponding channel as the third signal.

The controller 140 may provide a source start pulse SSP, a source clock SCLK, and a channel signal to a plurality of shift registers SR1 to SR4.

The plurality of shift registers SR1 to SR4 may generate sampling signals in response to the source start pulse SSP and the source clock SCLK input from the controller 140. The controller 140 may control the signal values of the channel signals CHS1 to CHS4 output from the plurality of shift registers SR1 to SR4.

For example, referring to FIG. 5, if a MSB value of the image data supplied to the first shift register SR1 changes from ‘0’ to ‘1’, the first shift register SR1 may output a first channel signal CHS1 corresponding to the first signal to the switch control unit 200.

If the MSB value of the image data supplied to the second shift register SR2 changes from ‘1’ to ‘0’, the second shift register SR2 may output a second channel signal CHS2 corresponding to the second signal to the switch control unit 200. If the MSB value of the image data supplied to the third shift register SR3 remains ‘0’, the third shift register SR3 may output a third channel signal CHS3 corresponding to the third signal to the switch control unit 200. If the MSB value of the image data supplied to the fourth shift register SR4 remains ‘1’, the fourth shift register SR4 may output a fourth channel signal CHS4 corresponding to the third signal to the switch control unit 200.

Since a data line DL connected to an output circuit outputting the first signal has a large amount of change in image data, the amount of increase in the data voltage VDATA may be greater than that of a data line DL connected to an output circuit outputting another signal. Accordingly, the data line DL connected to the output circuit outputting the first signal is required be pre-charged or charge-shared. Since a data line DL connected to an output circuit outputting the second signal has a large amount of change in image data, the amount of decrease in the data voltage VDATA may be greater than that of the data line DL connected to the output circuit outputting another signal. Accordingly, the data line DL connected to the output circuit outputting the second signal may be charge-shared with a data line DL connected to another output circuit. The switch control unit 200 may control the data lines DL connected to a plurality of output circuits so that a data line DL connected to an output circuit that outputting the first signal may be pre-charged or charge-shared. The switch control unit 200 may control data lines DL connected to a plurality of output circuits so that a data lines DL connected to an output circuit outputting the second signal can be charge-shared with a data lines DL connected to an output circuit outputting the first signal while there is a data line DL connected to the output circuit outputting the second signal.

For example, referring to FIG. 5, the switch control unit 200 may output a first control signal CS1 having a turn-on level to a gate node of a first switching transistor SWT1 based on a first signal corresponding to the first output circuit OC1 and a second signal corresponding to the second output circuit OC2. In this case, the switch control unit 200 may output a first switching signal SW1, a second switching signal SW2, a third switching signal SW3, a fourth switching signal SW4, a second control signal CS2, a third control signal CS3, a fourth control signal CS4, a fifth control signal CS5, and a sixth control signal CS6 having a turn-off level.

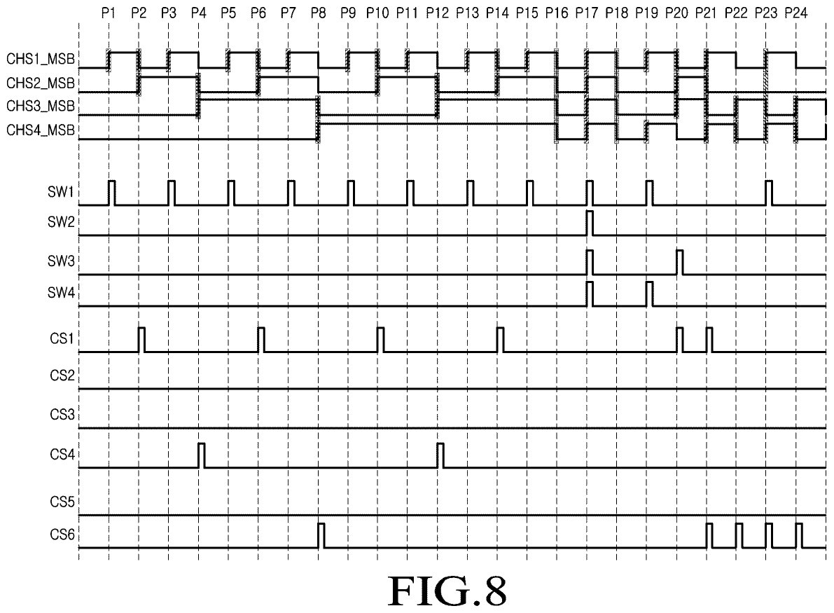

As the first switching transistor SWT1 is turned on, the first output circuit OC1 and the second output circuit OC2 may be connected. As the first output circuit OC1 and the second output circuit OC2 are connected, the first data line DL1 and the second data line DL2 can be charge-shared. Multiple cases for electrical connections between multiple output circuits are exemplified in the description below in FIG. 8.

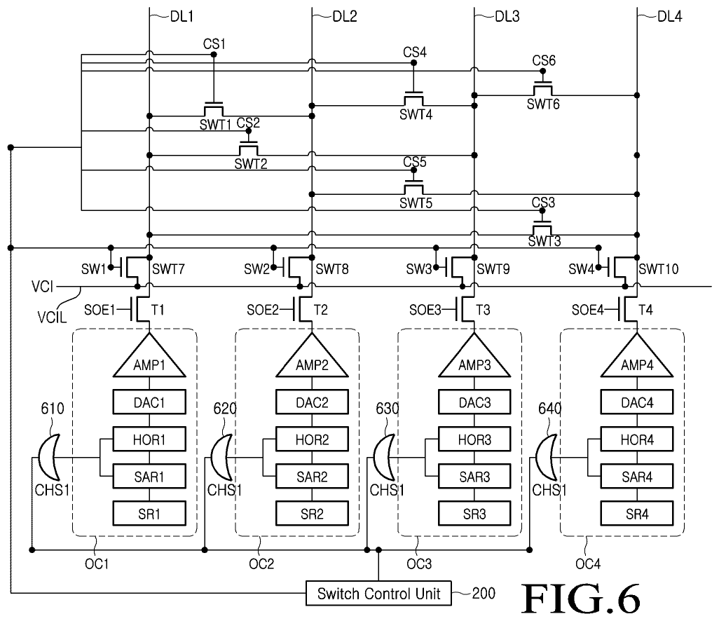

FIG. 6 illustrates a connection relationship between a plurality of switching transistors SWT1 to SWT10, a switch control unit 200, a plurality of output circuits OC1 to OC4, and a plurality of logic units 610, 620, 630 and 640 according to embodiments of the present disclosure.

In the description of FIG. 6, it will be omitted the description overlapping with FIG. 4.

Each of the plurality of output circuits may include a logic unit.

Referring to FIG. 6, a first output circuit OC1 may include a first logic unit 610 connected to a first sampling latch circuit SAR1 and a first holding latch circuit HOR1. A second output circuit OC2 may include a second logic unit 620 connected to a second sampling latch circuit SAR2 and a second holding latch circuit HOR2. A third output circuit OC3 may include a third logic unit 630 connected to a third sampling latch circuit SAR3 and a third holding latch circuit HOR3. A fourth output circuit OC4 may include a fourth logic unit 640 connected to a fourth sampling latch circuit SAR4 and a fourth holding latch circuit HOR4.

The first logic unit 610 may determine a first channel signal CHS1 by comparing the MSB value or the most significant 2 bits of the first image data sampled by the first sampling latch circuit SAR1 with the MSB value or the most significant 2 bits of the first image data supplied to the first holding latch circuit HOR1. The first logic unit 610 may output the determined first channel signal CHS1 to the switch control unit 200.

The second logic unit 620 may determine a second channel signal CHS2 by comparing the MSB value or the most significant 2 bits of the second image data sampled by the second sampling latch circuit SAR2 with the MSB value or the most significant 2 bits of the second image data supplied to the second holding latch circuit HOR2. The second logic unit 620 may output the determined second channel signal CHS2 to the switch control unit 200.

The third logic unit 630 may determine a third channel signal CHS3 by comparing the MSB value or the most significant 2 bits of the third image data sampled by the third sampling latch circuit SAR3 with the MSB value or the most significant 2 bits of the third image data supplied to the third holding latch circuit HOR3. The third logic unit 630 may output the determined third channel signal CHS3 to the switch control unit 200.

The fourth logic unit 640 may determine a fourth channel signal CHS4 by comparing the MSB value or the most significant 2 bits of the fourth image data sampled by the fourth sampling latch circuit SAR4 with the MSB value or the most significant 2 bits of the fourth image data supplied to the fourth holding latch circuit HOR4. The fourth logic unit 640 may output the determined fourth channel signal CHS4 to the switch control unit 200.

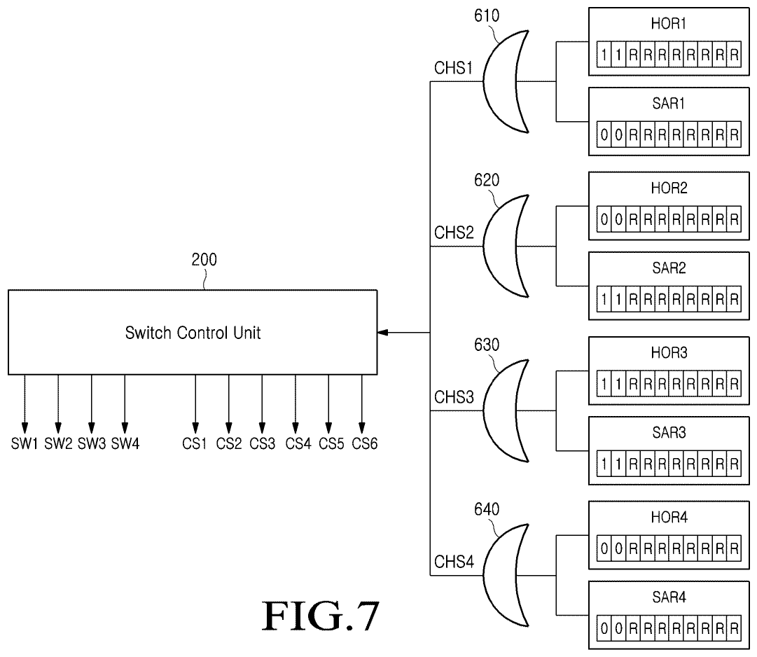

It will be exemplified an operation of each of the plurality of logic units determining the channel signal with reference to FIG. 7.

The switch control unit 200 may output each of the plurality of control signals and each of the plurality of switching signals to each of the plurality of switching transistors according to the channel signals received from the plurality of logic units. The plurality of switching transistors may control the electrical connection between the output circuits according to the plurality of control signals. The plurality of switching transistors may control the electrical connection between the control voltage line VCIL and the output circuit according to the plurality of switching signals.

Hereinafter, it will be described an operation of each of the plurality of logic units determining the channel signal.

FIG. 7 illustrates a switch control unit 200 that outputs a control signal according to a signal output from a logic unit according to embodiments of the present disclosure.

It will be omitted the description of the plurality of logic units overlapping with the description of FIG. 6.

Referring to FIG. 7, the first logic unit 610 may receive a value corresponding to the most significant 2 bits of the first image data sampled by the first sampling latch circuit SAR1 from the first sampling latch circuit SAR1. The first logic unit 610 may receive a value corresponding to the most significant 2 bits of the first image data supplied to the first holding latch circuit HOR1 from the first holding latch circuit HOR1. The first logic unit 610 may generate a first channel signal CHS1 based on the difference between the most significant 2 bits provided from the first sampling latch circuit SAR1 and the most significant 2 bits provided from the first holding latch circuit HOR1. The first channel signal CHS1 may be provided to the switch control unit 200.

For example, the first logic unit 610 may receive the most significant 2 bits having a value of ‘00’ from the first sampling latch circuit SAR1 and the most significant 2 bits having a value of ‘11’ from the first holding latch circuit HOR1. Accordingly, the first logic unit 610 may generate a two-bit first signal having a value of ‘01’.

Referring to FIG. 7, the second sampling latch circuit SAR2 may provide a value corresponding to the most significant 2 bits of the second image data to the second logic unit 620. The second holding latch circuit HOR2 may provide a value corresponding to the most significant 2 bits of the second image data to the second logic unit 620. The second logic unit 620 may generate a second channel signal CHS2 based on the difference between the most significant 2 bits provided from the second sampling latch circuit SAR2 and the second holding latch circuit HOR2.

For example, the second logic unit 620 may receive the most significant 2 bits having a value of ‘11’ from the second sampling latch circuit SAR2 and the most significant 2 bits having a value of ‘00’ from the second holding latch circuit HOR2. Accordingly, the second logic unit 620 may generate a two-bit second signal having a value of ‘10’. The second logic unit 620 may output the second channel signal CHS2 corresponding to the generated second signal to the switch control unit 200.

Referring to FIG. 7, the third logic unit 630 may receive a value corresponding to the most significant 2 bits of the third image data sampled by the third sampling latch circuit SAR3 from the third sampling latch circuit SAR3. The third logic unit 630 may receive a value corresponding to the most significant 2 bits of the third image data supplied to the third holding latch circuit HOR3 from the third holding latch circuit HOR3. The third logic unit 630 may generate a third channel signal CHS3 based on the difference between the most significant 2 bits provided from the third sampling latch circuit SAR3 and the third holding latch circuit HOR3. The third channel signal CHS3 may be provided to the switch control unit 200.

For example, the third logic unit 630 can receive the most significant 2 bits having the value of ‘11’ from the third sampling latch circuit SAR3 and the most significant 2 bits having the value of ‘11’ from the third holding latch circuit HOR3. Accordingly, the third logic unit 630 may generate a two-bit third signal having the value of ‘11’ or ‘00’.

Referring to FIG. 7, the fourth logic unit 640 may receive a value corresponding to the most significant 2 bits of the fourth image data sampled by the fourth sampling latch circuit SAR4 from the fourth sampling latch circuit SAR4. The fourth logic unit 640 may receive a value corresponding to the most significant 2 bits of the fourth image data supplied to the fourth holding latch circuit HOR4 from the fourth holding latch circuit HOR4. The fourth logic unit 640 may generate a fourth channel signal CHS4 based on the difference between the most significant 2 bits provided from the fourth sampling latch circuit SAR4 and the fourth holding latch circuit HOR4. The fourth channel signal CHS4 may be provided to the switch control unit 200.

For example, the fourth logic unit 640 may receive the most significant 2 bits having a value of ‘00’ from the fourth sampling latch circuit SAR4 and the most significant 2 bits having a value of ‘00’ from the fourth holding latch circuit HOR4. Accordingly, the fourth logic unit 640 may generate a two-bit third signal having a value of ‘00’ or ‘11’.

The switch control unit 200 may output a plurality of switching control signals and a plurality of control signals by receiving a first channel signal CHS1, a second channel signal CHS2, a third channel signal CHS3, and a fourth channel signal CHS4 from a first output circuit OC1, a second output circuit OC2, a third output circuit OC3, and a fourth output circuit OC4, respectively.

For example, the switch control unit 200 may receive a first signal from the first output circuit OC1. The switch control unit 200 may receive a second signal from the second output circuit OC2. The switch control unit 200 may receive a third signal from the third output circuit OC3. The switch control unit 200 may receive a third signal from the fourth output circuit OC4. The switch control unit 200 may output a first control signal CS1 of a turn-on level to a gate node of a first switching transistor SWT1 so that the first output circuit OC1 and the second output circuit OC2 can be charge-shared. The switch control unit 200 may output a first switching signal SW1, a second switching signal SW2, a third switching signal SW3, a fourth switching signal SW4, a second control signal CS2, a third control signal CS3, a fourth control signal CS4, a fifth control signal CS5, and a sixth control signal CS6 having turn-off levels.

Multiple cases for electrical connections between multiple output circuits will be exemplified in the description below in FIG. 8.

FIG. 8 is a timing diagram of a plurality of signals according to a change in MSB value according to embodiments of the present disclosure.

Referring to FIG. 8, the timing diagram may represent states of a first MSB value CHS1_MSB of a first output circuit OC1, a second MSB value CHS2_MSB of a second output circuit OC2, a third MSB value CHS3_MSB of a third output circuit OC3, and a fourth MSB value CHS4_MSB of a fourth output circuit OC4. The on/off levels of the first to fourth switching control signals SW1 to SW4 and the first to sixth control signals CS1 to CS6 may be controlled according to changes in each of the first to fourth MSB values CHS1_MSB, CHS2_MSB, CHS3_MSB and CHS4_MSB.

The timing diagram may represent turn-on states and turn-off states of the first switching signal SW1, the second switching signal SW2, the third switching signal SW3, the fourth switching signal SW4, the first control signal CS1, the second control signal CS2, the third control signal CS3, the fourth control signal CS4, the fifth control signal CS5, and the sixth control signal CS6.

The switch control unit 200 may control a plurality of switching transistors so that a data line DL connected to an output circuit where the MSB value transitions from ‘0’ to 1 and a data line DL connected to an output circuit where the MSB value transitions from ‘1’ to ‘0’ can be charge-shared.

The switch control unit 200 may control a plurality of switching transistors so that, among the data lines DL connected to the output circuits where the MSB value transitioned from ‘0’ to 1, a data line closest to the data line corresponding to the output circuit where the MSB value transitioned from ‘1’ to ‘0’ can be charge-shared.

If an output circuit with an increasing MSB value and an output circuit with a decreasing MSB value exist at the same time, a control signal for controlling a switching transistor that connects the data lines DL connected to the corresponding output circuits can be output at a turn-on level.

If there is only an output circuit with an increasing MSB value, a switching signal that turns on a switching transistor pre-charging the data line DL connected to the corresponding output circuit can be output at a turn-on level.

The timing diagram may include a plurality of periods during which a plurality of switching transistors are controlled while the source enable signal SOE is a low signal. The timing diagram may include a first period P1 to a 24-th period P24.

During the first period P1, the first MSB value CHS1_MSB may change from ‘0’ to ‘1’. The second MSB value CHS2_MSB, the third MSB value CHS3_MSB, and the fourth MSB value CHS4_MSB may not change.

The switch control unit 200 may output a first switching signal SW1 of a turn-on level to a gate node of a seventh switching transistor SWT7 in order to pre-charge the first data line DL1. The second switching signal SW2, the third switching signal SW3, the fourth switching signal SW4, the first control signal CS1, the second control signal CS2, the third control signal CS3, the fourth control signal CS4, the fifth control signal CS5, and the sixth control signal CS6 may have turn-off levels. The voltage of the pre-charged first data line DL1 can increase exponentially.

During a third period P3, a fifth period P5, a seventh period P7, a ninth period P9, an 11-th period P11, a 13-th period P13, and a 15-th period P15, the plurality of transistors SWT1 to SWT10 may operate as in the first period P1. That is, if at least one of the first to fourth MSB values CHS1_MSB, CHS2_MSB, CHS3_MSB and CHS4_MSB increases and the remaining first to fourth MSB values CHS1_MSB, CHS2_MSB, CHS3_MSB and CHS4_MSB are maintained, the data line corresponding to the output circuit whose MSB value increases can be pre-charged.

During a second period P2, the first MSB value CHS1_MSB of the first output circuit OC1 may be changed from ‘1’ to ‘0’. The second MSB value CHS2_MSB2 may be changed from ‘0’ to ‘1’. The third MSB value CHS3_MSB and the fourth MSB value CHS4_MSB may not be changed.

The switch control unit 200 may output a first control signal CS1 having a turn-on level to a gate node of a first switching transistor SWT1. The first switching signal SW1, the second switching signal SW2, the third switching signal SW3, the fourth switching signal SW4, the second control signal CS2, the third control signal CS3, the fourth control signal CS4, the fifth control signal CS5, and the sixth control signal CS6 may have a turn-off level.

In response to the first control signal CS1, the first switching transistor SWT1 is turned on, and the first data line DL1 and the second data line DL2 may be connected. Accordingly, the first data line DL1 and the second data line DL2 may be charge-shared. The voltage of the charge-shared data line DL may increase exponentially.

During a sixth period P6, a tenth period P10, and a 14-th period P14, the plurality of transistors SWT1 to SWT10 may operate as in the second period P2.

During a fourth period P4, the first MSB value CHS1_MSB may change from ‘1’ to ‘0’. The second MSB value CHS2_MSB may change from ‘1’ to ‘0’. The third MSB value CHS3_MSB may change from ‘0’ to ‘1’. The fourth MSB value CHS4_MSB may not change.

The switch control unit 200 may output a fourth control signal CS4 having a turn-on level to a gate node of a fourth switching transistor SWT4. The first switching signal SW1, the second switching signal SW2, the third switching signal SW3, the fourth switching signal SW4, the first control signal CS1, the second control signal CS2, the third control signal CS3, the fifth control signal CS5, and the sixth control signal CS6 may have turn-off levels.

In response to the fourth control signal CS4 of the turn-on level, the fourth switching transistor SWT4 may be turned on, and the second data line DL2 and the third data line DL3 may be connected. Accordingly, the second data line DL2 and the third data line DL3 may be charge-shared.

During a 12-th period P12, the plurality of transistors SWT1 to SWT10 may operate in the same manner as in the fourth period P4.

During an eighth period P8, the first MSB value CHS1_MSB may be changed from ‘1’ to ‘0’. The second MSB value CHS2_MSB may be changed from ‘1’ to ‘0’. The third MSB value CHS3_MSB may be changed from ‘1’ to ‘0’. The fourth MSB value CHS4_MSB may be changed from ‘0’ to ‘1’.

The switch control unit 200 may output a sixth control signal CS6 having a turn-on level to a gate node of a sixth switching transistor SWT6. That is, among the data lines DL1, DL2 and DL3 connected to the output circuit in which the MSB value transitions from ‘1’ to ‘0’, the sixth switching transistor SWT6 connecting the third data line DL3 that are closest to the fourth data line DL4 connected to the output circuit in which the MSB value transitions from ‘0’ to ‘1’ and the fourth data line DL4 can be turned on. The first switching signal SW1, the second switching signal SW2, the third switching signal SW3, the fourth switching signal SW4, the first control signal CS1, the second control signal CS2, the third control signal CS3, the fourth control signal CS4, and the fifth control signal CS5 may have turn-off levels.

If the sixth switching transistor SWT6 is turned on, the third data line DL3 and the fourth data line DL4 may be connected. Accordingly, the third data line DL3 and the fourth data line DL4 may be charge-shared.

During a 16-th period P16, the first MSB value CHS1_MSB, the second MSB value CHS2_MSB, the third MSB value CHS3_MSB, and the fourth MSB value CHS4_MSB may be changed from ‘1’ to ‘0’.

Accordingly, the first switching signal SW1, the second switching signal SW2, the third switching signal SW3, the fourth switching signal SW4, the first control signal CS1, the second control signal CS2, the third control signal CS3, the fourth control signal CS4, the fifth control signal CS5, and the sixth control signal CS6 may have turn-off level voltages. For example, if the first signal is not provided (i.e., when only at least some of the second and third signals are output), the switch control unit 200 may turn off all the switching transistors and the charge-share transistors.

During a 18-th period P18, the plurality of transistors SWT1 to SWT10 may operate as in the 16-th period P16.

During a 17-th period P17, the first MSB value CHS1_MSB, the second MSB value CHS2_MSB, the third MSB value CHS3_MSB, and the fourth MSB value CHS4_MSB may be changed from ‘0’ to ‘1’.

Accordingly, the switch control unit 200 may output the first switching signal SW1, the second switching signal SW2, the third switching signal SW3, and the fourth switching signal SW4 having turn-on levels to the gate node of the seventh switching transistor SWT7, the gate node of the eighth switching transistor SWT8, the gate node of the ninth switching transistor SWT9, and the gate node of the tenth switching transistor SWT10, respectively. The first control signal CS1, the second control signal CS2, the third control signal CS3, the fourth control signal CS4, the fifth control signal CS5, and the sixth control signal CS6 may have turn-off level voltages.

Accordingly, the seventh switching transistor SWT7, the eighth switching transistor SWT8, the ninth switching transistor SWT9, and the tenth switching transistor SWT10 may be turned on. Accordingly, the first to fourth data lines DL1 to DL4 may be pre-charged.

In this way, in the case that only the first signal is output from the output circuits (i.e., a case in which the MSB of the image data transitions from 0 to 1), the data lines corresponding to the first signal output may be pre-charged.

During a 19-th period P19, the first MSB value CHS1_MSB and the fourth MSB value CHS4_MSB may be changed from ‘0’ to ‘1’. The second MSB value CHS2_MSB and the third MSB value CHS3_MSB may not be changed.

Therefore, the switch control unit 200 may output a first switching signal SW1 of a turn-on level to the gate node of the seventh switching transistor SWT7 to pre-charge the first data line DL1. The switch control unit 200 may output a fourth switching signal SW4 of a turn-on level to the gate node of the tenth switching transistor SWT10 to pre-charge the fourth data line DL4.

During a 20-th period P20, the second MSB value CHS2_MSB, and the third MSB value CHS3_MSB may be changed from ‘0’ to ‘1’. The first MSB value CHS1_MSB, and the fourth MSB value CHS4_MSB may be changed from ‘1’ to ‘0’.

Accordingly, the switch control unit 200 may output the first control signal CS1 having a turn-on level to the gate node of the first switching transistor SWT1, respectively. The second control signal CS2, the third control signal CS3, the fourth control signal CS4, the fifth control signal CS5, and the sixth control signal CS6 may have turn-off level voltages.

The switch control unit 200 may output the third switching signal SW3 having a turn-on level to the gate node of the ninth switching transistor SWT9 in order to pre-charge the third data line DL3.

During a 21-st period P21, the MSB values of the first MSB value CHS1_MSB and the fourth MSB value CHS4_MSB may be changed from ‘0’ to ‘1’. The second MSB value CHS2_MSB and the third MSB value CHS3_MSB may be changed from ‘1’ to ‘0’.

Accordingly, the switch control unit 200 may output the first control signal CS1 and the sixth control signal CS6 having a turn-on level to the gate node of the first switching transistor SWT1 and the gate node of the sixth switching transistor SWT6, respectively. Here, the data line connected to the output circuit in which the MSB value transitions from ‘0’ to ‘1’ may be connected to the closest one of the data lines in which the MSB value transitions from ‘1’ to ‘0’. For example, the first data line DL1 may be connected to the second data line DL2, and the third data line DL3 may be connected to the fourth data line DL4.

During a 22-nd period P22, the first MSB value CHS1_MSB may change from ‘1’ to ‘0’. The second MSB value CHS2_MSB may not change. The third MSB value CHS3_MSB may change from ‘0’ to ‘1’. The fourth MSB value (CHS4_MSB) may change from ‘1’ to ‘0’.

Accordingly, the switch control unit 200 may output the sixth control signal CS6 having the turn-on level to the gate node of the sixth switching transistor SWT6. The first switching signal SW1, the second switching signal SW2, the third switching signal SW3, the fourth switching signal SW4, the first control signal CS1, the second control signal CS2, the third control signal CS3, the fourth control signal CS4, and the fifth control signal CS5 may have turn-off levels.

As the sixth switching transistor SWT6 is turned on, the third data line DL3 and the fourth data line DL4 may be connected. Accordingly, the third data line DL3 and the fourth data line DL4 may be charge-shared.

During a 24-th period P24, the plurality of transistors SWT1 to SWT10 may operate in the same manner as in the 22-nd period P22.

During a 23-rd period P23, the first MSB value CHS1_MSB may change from ‘0’ to ‘1’. The second MSB value CHS2_MSB may not change. The third MSB value CHS3_MSB may change from ‘1’ to ‘0’. The fourth MSB value CHS2_MSB4 may change from ‘0’ to ‘1’.

Accordingly, the switch control unit 200 may output the sixth control signal CS6 and the first switching signal SW1 having a turn-on level. Accordingly, the third data line DL3 and the fourth data line DL4 may be charge-shared, and the data line DL1 may be pre-charged. That is, the third data line DL3 may charge-share with the fourth data line DL4 that is the closest data line among the data lines DL1 and DL4 connected to the output circuits whose MSB values transition from ‘0’ to ‘1’, and the remaining first data line DL1 may be pre-charged.

The second switching signal SW2, the third switching signal SW3, the fourth switching signal SW4, the first control signal CS1, the second control signal CS2, the third control signal CS3, the fourth control signal CS4, and the fifth control signal CS5 may have turn-off level voltages.

Hereinafter, it will be described power improvement according to pre-charge and charge-share.

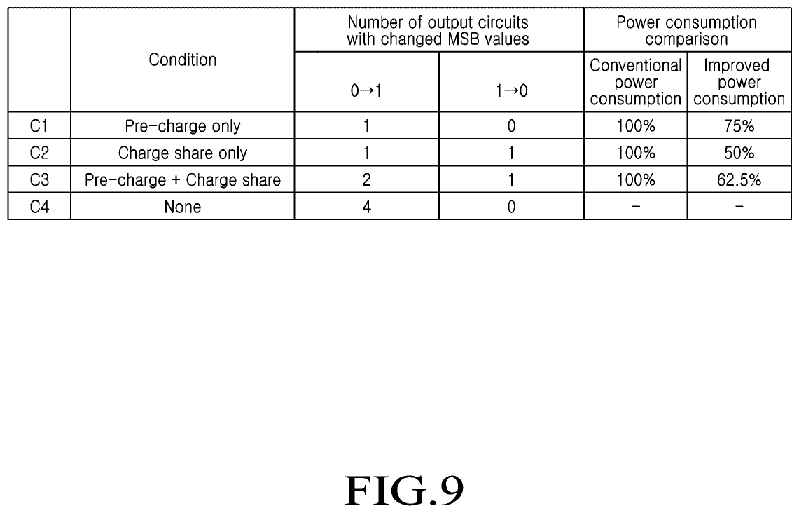

FIG. 9 is a table illustrating power consumption reduction conditions according to embodiments of the present disclosure.

In the case of pre-charge or charge-share, the step of increasing the voltage required for the data line DL is divided. Accordingly, the amount of voltage change is reduced, and thus the amount of power required can also be reduced.

Referring to FIG. 9, a plurality of output circuits can be pre-charged and charged-shared according to a plurality of examples for pre-charge and charge-share. For example, the plurality of examples may include a first example C1 having a condition in which only pre-charge occurs, a second example C2 having a condition in which only charge-share occurs, a third example C3 having a condition in which both pre-charge and charge-share occur, and a fourth example C4 in which neither pre-charge nor charge-share occurs. Hereinafter, the power consumption is described in accordance with the following conditions: a driving voltage is 6 V, a voltage output from the control voltage line VCIL is 3 V, and a data voltage VDATA is full-swing. The full swing of the driving voltage, the voltage output from control voltage line VCIL and data voltage VDATA may be modified.

According to the first example C1 in which the number of output circuits where the MSB value changes from ‘0’ to ‘1’ is 1 and the number of output circuits where the value of MSB changes from ‘1’ to ‘0’ is zero, the corresponding output circuit may be pre-charged. In this case, the power consumption of the output circuit can be reduced by 25%.

For example, in order to output the data voltage VDATA, the output circuit may require 6 mW of power according to a voltage of 6V and a current of 1 mA. The output circuit pre-charged according to the first example C1 may require 1.5 mW of power according to a voltage of 3V and a current of 0.5 mA during pre-charging. The output circuit pre-charged according to the first example C1 may require 3 mW of power according to a voltage of 6V and a current of 0.5 mA while the data voltage VDATA is output. Accordingly, the output circuit pre-charged according to the first example C1 may require 4.5 mW of power to output the data voltage VDATA. Accordingly, the output circuit pre-charged according to the first example C1 may output the data voltage VDATA with 75% of the power used in the existing output circuit.

According to the second example C2 in which the number of output circuits where the MSB value changes from ‘0’ to ‘1’ is 1 and the number of output circuits where the value of MSB changes from ‘1’ to ‘0’ is 1, the corresponding output circuit may be charge-shared. Power consumption of charge-sharing output circuits can be reduced by 50%.

For example, the power required for two output circuits to output data voltage VDATA may be 12 mW according to a voltage of 6V and a current of 1 mA. The two output circuits that are charge-shared may be required to have 6 mW of power while the data voltage VDATA is output. Accordingly, the output circuit that is charge-shared according to the second example C2 can output the data voltage VDATA with 50% of the power used by the existing output circuit.

According to the third example C3 in which the number of output circuits where the MSB value changes from ‘0’ to ‘1’ is 2 and the number of output circuits where the value of MSB changes from ‘1’ to ‘0’ is 1, the output circuits can be pre-charged and charge-shared.

Referring to the description in the first example C1, the pre-charged output circuit may require 4.5 mW of power. Referring to the description in the second example C2, the charge-shared output circuit may require 3 mW of power. Accordingly, the charge-shared output circuit and the pre-charged output circuit may require 7.5 mW of power. The two existing output circuits may require 12 mW of power. Accordingly, the charge-shared output circuit and the pre-charged output circuit can output the data voltage VDATA with 62.5% of the power used by the two existing output circuits.

According to the fourth example C4 in which the number of output circuits where the MSB value changes from ‘0’ to ‘1’ is 4 and the number of output circuits where the value of MSB changes from ‘1’ to ‘0’ is zero, the output circuit may not be pre-charged and charge-shared.

In the case in which the number of output circuits in which the MSB value changed from ‘1’ to ‘0’ is 4 and there is no output circuit in which the MSB value changed from ‘0’ to ‘1’, the output circuit may operate as in the fourth example C4.

Embodiments of the present disclosure described above are briefly described as follow.

A display device according to embodiments of the present disclosure may include a display panel in which a plurality of sub-pixels are arranged and which is configured to display an image, a data driving circuit configured to supply data voltages to the plurality of sub-pixels through data lines, first switches configured to supply pre-charge voltages to the data lines, and second switches that connect two data lines among the data lines.

The data driving circuit is configured to sequentially supply a data voltage corresponding to image data to a plurality of sub-pixels, to output a switching signal to each of the first switches based on an amount of change in the image data sequentially outputted, and to output a control signal to each of the second switches based on the amount of change in the image data.

The data driving circuit may include a first output circuit configured to sequentially output data voltages corresponding to first image data to a first sub-pixel among the plurality of sub-pixels through a first data line, a second output circuit is configured to sequentially output data voltages corresponding to second image data to a second sub-pixel among the plurality of sub-pixels through a second data line, a third output circuit is configured to sequentially output data voltages corresponding to third image data to a third sub-pixel among the plurality of sub-pixels through a third data line, and a fourth output circuit is configured to sequentially output data voltages corresponding to fourth image data to a fourth sub-pixel among the plurality of sub-pixels through a fourth data line.

The second switches may include a first switching transistor configured to connect the first data line and the second data line according to a first control signal, a second switching transistor configured to connect the first data line and the third data line according to a second control signal, a third switching transistor configured to connect the first data line and the fourth data line according to a third control signal, a fourth switching transistor configured to connect the second data line and the third data line according to a fourth control signal, a fifth switching transistor configured to connect the second data line and the fourth data line according to a fifth control signal, and a sixth switching transistor configured to connect the third data line and the fourth data line according to a sixth control signal.

The first switches may include a first pre-charge transistor configured to connect the first data line and a control voltage line for applying a pre-charge voltage according to a first switching signal, a second pre-charge transistor configured to connect the control voltage line and the second data line according to a second switching signal, third pre-charge transistor configured to connect the control voltage line and the third data line according to a third switching signal, and a fourth pre-charge transistor configured to connect the control voltage line and the fourth data line according to a fourth switching signal.

Each of the first output circuit, the second output circuit, the third output circuit, and the fourth output circuit is configured to supply an output signal having one of a first signal, a second signal and a third signal to a switch control unit of the data driving circuit based on a change in a most-significant-bit (MSB) value of respective image data.

If the MSB value of at least one output circuit transitions from 0 to 1, an output circuit whose MSB value transitions from 0 to 1 may supply the first signal to the switch control unit.

If the MSB value of at least one output circuit transitions from 1 to 0, an output circuit whose MSB value transitions from 1 to 0 may supply the second signal to the switch control unit.

If the MSB value of at least one output circuit does not change, an output circuit whose MSB value does not change may supply the third signal to the switch control unit.

Each of the first output circuit, the second output circuit, the third output circuit, and the fourth output circuit may be configured to supply an output signal having one of a first signal, a second signal and a third signal to a switch control unit of the data driving circuit based on a change in a value of most significant 2 bits of the image data.

If the value of the most significant 2 bits of at least one output circuit transitions from 00 to 11, an output circuit whose value of the most significant 2 bit transitions from 00 to 11 may be configured to supply the first signal to the switch control unit.

If the value of the most significant 2 bits of at least one output circuit transitions from 11 to 00, an output circuit whose value of the most significant 2 bit transitions from 11 to 00 may be configured to supply the second signal to the switch control unit.

If the value of the most significant 2 bits of at least one output circuit transitions from 00 to 10, an output circuit whose value of the most significant 2 bit transitions from 00 to 10 may be configured to supply the first signal to the switch control unit.

If the value of the most significant 2 bits of at least one output circuit transitions from 11 to 01, an output circuit whose value of the most significant 2 bit transitions from 11 to 01 may be configured to supply the second signal to the switch control unit.

If the first signal and the second signal are output among output signals of the first output circuit, the second output circuit, the third output circuit, and the fourth output circuit, a switching transistor connecting a data line corresponding to an output circuit outputting the first signal and a data line corresponding to an output circuit outputting the second signal may be turned on.

Among data lines corresponding to the output circuit outputting the first signal, a data line closest to the data line corresponding to the output circuit outputting the second signal may be connected to the data line corresponding to the output circuit outputting the second signal.

If at least one of the output signals of the first output circuit, the second output circuit, the third output circuit, and the fourth output circuit is the first signal and the remaining output signals are the third signal, a pre-charge transistor of a data line corresponding to an output circuit supplying the first signal may be turned on.

If there are more output circuits outputting the first signal than output circuits outputting the second signal, a switching transistor connecting a data line closest to a data line corresponding to an output circuit outputting the second signal among data lines corresponding to an output circuit outputting the first signal and a data line corresponding to the output circuit outputting the second signal may be turned on.

In the case, a pre-charge transistor connected to the data line corresponding to the output circuit that outputs the first signal and not connected to the turned-on switching transistor may be turned on.

If there are more output circuits outputting the second signal than output circuits outputting the first signal, a switching transistor connecting a data line closest to a data line corresponding to an output circuit outputting the first signal among data lines corresponding to an output circuit outputting the second signal and a data line corresponding to an output circuit outputting the first signal may be turned on.

In this case, a pre-charge transistors connected to the data line corresponding to the output circuit that outputs the second signal and not connected to the turn-on switching transistor may be turned off.

Each of the first output circuit, the second output circuit, the third output circuit, and the fourth output circuit may include a logic unit configured to output one of a first signal, a second signal, and a third signal to a switch control unit based on a change in an MSB value of image data.

If an MSB value of an output circuit including the logic unit transitions from 0 to 1, the logic unit may output the first signal.

If an MSB value of an output circuit including the logic unit transitions from 1 to 0, the logic unit may output the second signal.

If an MSB value of an output circuit including the logic unit does not change, the logic unit may output the third signal.

The display device may further include a controller is configured to supply image data to the data driving circuit.

The controller is configured to provide at least one of a first signal, a second signal, and a third signal to at least one of the first output circuit, the second output circuit, the third output circuit, and the fourth output circuit, based on an MSB value of the corresponding image data output from each of the first output circuit, the second output circuit, the third output circuit, and the fourth output circuit.

If the MSB value of the corresponding image data transitions from 0 to 1, the controller may provides the first signal to an output circuit where the MSB value of the corresponding image data transitions from 0 to 1.

If the MSB value of the corresponding image data transitions from 1 to 0, the controller may provides the second signal to an output circuit where the MSB value of corresponding the image data transitions from 1 to 0.

If the MSB value of the corresponding image data does not change, the controller may provide the third signal to an output circuit where the MSB value of the corresponding image data does not change.

The output circuit provided with the first signal is configured to supply the first signal to a switch control unit, the output circuit provided with the second signal is configured to supply the second signal to the switch control unit, and the output circuit provided with the third signal is configured to supply the third signal to the switch control unit.

The above description has been presented to enable any person skilled in the art to make and use the technical idea of the present invention, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present invention. The above description and the accompanying drawings provide an example of the technical idea of the present invention for illustrative purposes only. That is, the disclosed embodiments are intended to illustrate the scope of the technical idea of the present invention.

What is claimed is:

1. A display device, comprising:
a display panel in which a plurality of sub-pixels are arranged and which is configured to display an image;
a data driving circuit configured to supply data voltages to the plurality of sub-pixels through data lines;
first switches configured to supply pre-charge voltages to the data lines; and
second switches that connect two data lines among the data lines,
wherein the data driving circuit is configured to sequentially supply data voltages corresponding to image data to the plurality of sub-pixels, to output a switching signal to each of the first switches based on an amount of change in the image data sequentially outputted, and to output a control signal to each of the second switches based on the amount of change in the image data.

2. The display device of claim 1, wherein the data driving circuit includes:
a first output circuit configured to sequentially output data voltages corresponding to first image data to a first sub-pixel among the plurality of sub-pixels through a first data line;
a second output circuit configured to sequentially output data voltages corresponding to second image data to a second sub-pixel among the plurality of sub-pixels through a second data line;
a third output circuit configured to sequentially output data voltages corresponding to third image data to a third sub-pixel among the plurality of sub-pixels through a third data line; and
a fourth output circuit configured to sequentially output data voltages corresponding to fourth image data to a fourth sub-pixel among the plurality of sub-pixels through a fourth data line, and
wherein the second switches include:
a first switching transistor configured to connect the first data line and the second data line according to a first control signal;
a second switching transistor configured to connect the first data line and the third data line according to a second control signal;
a third switching transistor configured to connect the first data line and the fourth data line according to a third control signal;
a fourth switching transistor configured to connect the second data line and the third data line according to a fourth control signal;
a fifth switching transistor configured to connect the second data line and the fourth data line according to a fifth control signal; and
a sixth switching transistor configured to connect the third data line and the fourth data line according to a sixth control signal.

3. The display device of claim 2, wherein the first switches include:
a first pre-charge transistor configured to connect the first data line and a control voltage line for applying a pre-charge voltage, according to a first switching signal;
a second pre-charge transistor configured to connect the control voltage line and the second data line according to a second switching signal;
third pre-charge transistor configured to connect the control voltage line and the third data line according to a third switching signal; and
a fourth pre-charge transistor configured to connect the control voltage line and the fourth data line according to a fourth switching signal.

4. The display device of claim 3, wherein each of the first output circuit, the second output circuit, the third output circuit, and the fourth output circuit is configured to supply an output signal having one of a first signal, a second signal and a third signal to a switch control unit of the data driving circuit based on a change in a most-significant-bit (MSB) value of respective image data.

5. The display device of claim 4, wherein, if the MSB value of at least one output circuit transitions from 0 to 1, an output circuit whose MSB value transitions from 0 to 1 supplies the first signal to the switch control unit,
wherein, if the MSB value of at least one output circuit transitions from 1 to 0, an output circuit whose MSB value transitions from 1 to 0 supplies the second signal to the switch control unit, and
wherein, if the MSB value of at least one output circuit does not change, an output circuit whose MSB value does not change supplies the third signal to the switch control unit.

6. The display device of claim 3, wherein each of the first output circuit, the second output circuit, the third output circuit, and the fourth output circuit is configured to supply an output signal having one of a first signal, a second signal and a third signal to a switch control unit of the data driving circuit based on a change in a value of most significant 2 bits of the image data.

7. The display device of claim 6, wherein, if the value of the most significant 2 bits of at least one output circuit transitions from 00 to 11, an output circuit whose value of the most significant 2 bit transitions from 00 to 11 is configured to supply the first signal to the switch control unit,
wherein, if the value of the most significant 2 bits of at least one output circuit transitions from 11 to 00, an output circuit whose value of the most significant 2 bit transitions from 11 to 00 is configured to supply the second signal to the switch control unit,
wherein, if the value of the most significant 2 bits of at least one output circuit transitions from 00 to 10, an output circuit whose value of the most significant 2 bit transitions from 00 to 10 is configured to supply the first signal to the switch control unit,
wherein, if the value of the most significant 2 bits of at least one output circuit transitions from 11 to 01, an output circuit whose value of the most significant 2 bit transitions from 11 to 01 configured to supply the second signal to the switch control unit, and
wherein, if the value of the most significant 2 bits of at least one output circuit does not change, an output circuit whose value of the most significant 2 bits does not change is configured to supply the third signal to the switch control unit.

8. The display device of claim 5, wherein, if the first signal and the second signal are output among output signals of the first output circuit, the second output circuit, the third output circuit, and the fourth output circuit, a switching transistor connecting a data line corresponding to an output circuit outputting the first signal and a data line corresponding to an output circuit outputting the second signal is turned on.

9. The display device of claim 8, wherein, among data lines corresponding to the output circuit outputting the first signal, a data line closest to the data line corresponding to the output circuit outputting the second signal is connected to the data line corresponding to the output circuit outputting the second signal.

10. The display device of claim 5, wherein, if at least one of the output signals of the first output circuit, the second output circuit, the third output circuit, and the fourth output circuit is the first signal and remaining output signals are the third signal, a pre-charge transistor of a data line corresponding to an output circuit supplying the first signal is turned on.

11. The display device of claim 5, wherein, if there are more output circuits outputting the first signal than output circuits outputting the second signal, a switching transistor connecting a data line closest to a data line corresponding to an output circuit outputting the second signal among data lines corresponding to an output circuit outputting the first signal and a data line corresponding to the output circuit outputting the second signal is turned on, and a pre-charge transistor connected to the data line corresponding to the output circuit that outputs the first signal and not connected to the turned-on switching transistor is turned on.

12. The display device of claim 5, wherein, if there are more output circuits outputting the second signal than output circuits outputting the first signal, a switching transistor connecting a data line closest to a data line corresponding to an output circuit outputting the first signal among data lines corresponding to an output circuit outputting the second signal and a data line corresponding to an output circuit outputting the first signal is turned on, and a pre-charge transistor connected to the data line corresponding to the output circuit that outputs the second signal and not connected to the turn-on switching transistor are turned off.

13. The display device of claim 3, wherein each of the first output circuit, the second output circuit, the third output circuit, and the fourth output circuit includes a logic unit configured to output one of a first signal, a second signal, and a third signal to a switch control unit of the data driving circuit based on a change in an MSB value of image data.

14. The display device of claim 13, wherein, if an MSB value of an output circuit including the logic unit transitions from 0 to 1, the logic unit outputs the first signal,
wherein, if an MSB value of an output circuit including the logic unit transitions from 1 to 0, the logic unit outputs the second signal, and
wherein, if an MSB value of an output circuit including the logic unit does not change, the logic unit outputs the third signal.

15. The display device of claim 3, further comprising a controller configured to supply image data to the data driving circuit,
wherein the controller is configured to provide at least one of a first signal, a second signal, and a third signal to at least one of the first output circuit, the second output circuit, the third output circuit, and the fourth output circuit, based on an MSB value of corresponding image data output from each of the first output circuit, the second output circuit, the third output circuit, and the fourth output circuit.

16. The display device of claim 15, wherein, if the MSB value of the corresponding image data transitions from 0 to 1, the controller provides the first signal to an output circuit where the MSB value of the corresponding image data transitions from 0 to 1,
wherein, if the MSB value of the corresponding image data transitions from 1 to 0, the controller provides the second signal to an output circuit where the MSB value of the corresponding image data transitions from 1 to 0, and
wherein, if the MSB value of the corresponding image data does not change, the controller provides the third signal to an output circuit where the MSB value of the corresponding image data does not change.

17. The display device of claim 16, wherein the output circuit provided with the first signal is configured to supply the first signal to a switch control unit, the output circuit provided with the second signal is configured to supply the second signal to the switch control unit, and the output circuit provided with the third signal is configured to supply the third signal to the switch control unit.
